(19) United States
(12) Patent Application Publication
(10) Pub. No.: US 2006/0073387 A1
(43) Pub. Date: Apr. 6, 2006

(54) Negative electrode for lithium secondary battery, method for producing same, and lithium secondary battery using same

(75) Inventors: Haruo Sakagoshi, Osaka (JP); Masuhiro Onishi, Osaka (JP); Hyo Azuma, Osaka (JP); Seiji Ishizawa, Osaka (JP); Fumio Togawa, Osaka (JP); Shuichi Wada, Osaka (JP)

Correspondence Address: OSHA LIANG L.L.P., 1221 MCKINNEY STREET, SUITE 2800, HOUSTON, TX, 77010, US

(73) Assignee: Hitachi Maxell, Ltd., Osaka (JP)

(21) Appl. No.: 10/539,719

(22) PCT Filed: Jan. 21, 2004
(86) PCT No.: PCT/JP04/00463

§ 371 Date: Jun. 20, 2005

(30) Foreign Application Priority Data
Jan. 22, 2003 (JP) 2003-013117
Jul. 4, 2003 (JP) 2003-191909
Jan. 8, 2004 (JP) 2004-002649

(51) Int. Cl. H01M 4/58; C01B 31/04; B05D 5/12

(52) U.S. Cl. 429/231.8; 252/182.1; 423/448; 427/122

(57) ABSTRACT

A lithium secondary battery includes a positive electrode, a negative electrode and nonaqueous electrolyte, wherein the negative electrode includes a negative active material and a binder, the negative active material comprises graphite A and graphite B, shapes of primary particles of the graphite A are spherical or elliptical, an average particle diameter of the primary particles of the graphite A ranges between 10 μm and 30 μm inclusive, sizes of crystallites of the graphite A in a direction of a c-axis are smaller than 100 nm and tap density of the graphite A is 1.0 g/cm³ or higher, shapes of primary particles of the graphite B are flat, an average particle diameter of the primary particles of the graphite B ranges between 1 μm and 10 μm inclusive, and sizes of crystallites of the graphite B in a direction of a c-axis are 100 nm or larger, which has a large capacity and excellent cycle characteristics.

### TECHNICAL FIELD

The present invention relates to a negative electrode for lithium secondary batteries, more specifically, a negative electrode for low-cost lithium secondary batteries with a large capacity and excellent cycle characteristics.

### BACKGROUND ART

Recently, due to the development of portable electronic equipment such as mobile phones and notebook-sized personal computers, and for the consideration the environment and the resource savings, there is increasing demand for large-capacity secondary batteries that can be charged and discharged repeatedly. Because of high energy density, lightweight, compactness, and excellent charge-discharge cycle characteristics, lithium secondary batteries are widely used as power supply for portable electronic equipment, and techniques for further increasing the capacities and improving the cycle characteristics are required because of an increase of the electricity consumed by the portable electronic equipment.

In a lithium secondary battery, a complex oxide including lithium such as LiCoO₂, LiNiO₂ and LiMn₂O₄ is used as a positive active material, and a carbon material that can intercalate and deintercalate lithium is used as a negative active material. Recently, in order to increase the capacities, carbon materials for negative electrodes has been mainly developed. Furthermore, there is a trend that not amorphous carbon materials but high-crystalline carbon materials are used as carbon materials to obtain higher energy density and higher voltage.

Among the existing carbon materials, natural graphite has the highest crystallinity and the largest discharge capacity, and artificial graphite such as mesocarbon microbeads (MCMB) obtained by graphitization at approximately 3000° C. also has high crystallinity and a large discharge capacity. However, they have a problem that the capacity thereof decreases significantly according to charge-discharge cycles.

For improving various characteristics including cycle characteristics, it is known that adding vapor growth carbon fibers (VGCF), carbon black or the like into negative active materials is effective (for example, see JP6(1994)-111818A (pages 2 to 4, Table 1), JP10(1998)-149833A (pages 2 to 6, Tables 1 to 3), JP11(1999)-176442A (pages 2 to 7, FIGS. 2 to 7) and JP2001-68110A (pages 2 to 5, Table 1)). However, these different types of carbons generally have a smaller discharge capacity than graphite negative active materials, and may reduce the energy density of the graphite negative active materials, which is originally high advantageously. In addition, the vapor growth carbon fibers result in a high cost.

Also, it is known that adding artificial graphite by 10% to 50% into natural graphite improves safety (for example, see JP5(1993)-290844A (pages 2 to 4, FIG. 3)). However, according to the study by the inventors, it is realized that, since general artificial graphite, for example, MCMB, has a relatively large average particle diameter of primary particles ranging from 10 to 30 μm, when such general artificial graphite is used being mixed with natural graphite, which has an average particle diameter of primary particles ranging from 10 to 30 μm, there are few contact points between the particles. Thus, cycle characteristics are not sufficient.

Moreover, the use of a negative active material composed of graphite covered with non-graphite carbon on surfaces thereof and other graphite to increase a capacity and a charge-discharge efficiency (for example, see JP2000-138061A (pages 2 to 8, Tables 2 and 3)) and to increase capacity and obtain a favorable capacity retention rate at room temperature and low temperature (for example, see JP2001-185147A (pages 2 to 7, Table 1)) is known. Furthermore, it is known that the results of analysis of the graphite by Raman spectrum are specified (for example, see JP4(1992)-368778A (pages 2 to 5, Tables 1 and 2), JP5(1993)-159771A (pages 2 to 7, FIG. 2), JP9(1997)-171815A (pages 2 to 4, FIGS. 1 and 2)). However, according to the study of the inventors, it is found that the increase of the capacity and the improvement of the cycle characteristics are not sufficiently satisfactory even by these techniques.

As mentioned above, the conventional techniques hardly can provide a lithium secondary battery having a large capacity and satisfying cycle characteristics sufficiently.

### DISCLOSURE OF INVENTION

In accordance with one or more embodiments of the present invention, a negative active material composed of carbon materials is improved so as to provide a lithium secondary battery having a large capacity and excellent cycle characteristics.

As a result of the study, the inventors found that a negative electrode for lithium secondary batteries with a large capacity and excellent cycle characteristics can be obtained by: using two kinds of graphite having certain shapes, particle diameters and properties as a negative active material that is composed of carbon materials; applying paint that is obtained by adding a binder into the graphite on a collector; drying the paint; and pressing treatment (calendering).

One or more embodiments of the present invention provide a negative electrode for lithium secondary batteries, comprising a negative active material and a binder, wherein the negative active material comprises graphite A and graphite B, shapes of primary particles of the graphite A are spherical or elliptical, an average particle diameter of the primary particles of the graphite A ranges between 10 μm and 30 μm inclusive, sizes of crystallites of the graphite A in a direction of a c-axis are smaller than 100 nm and tap density of the graphite A is 1.0 g/cm³ or higher, shapes of primary particles of the graphite B are flat, an average particle diameter of the primary particles of the graphite B ranges between 1 μm and 10 μm inclusive, and sizes of crystallites of the graphite B in a direction of a c-axis are 100 nm or larger.

In addition, one or more embodiments of the present invention provide a method for manufacturing a negative electrode for lithium secondary batteries comprising the steps of: preparing graphite A of which shapes of primary particles are spherical or elliptical, an average particle diameter of the primary particles ranges between 10 μm and 30 μm inclusive, sizes of crystallites in a direction of a c-axis are smaller than 100 nm, and tap density is 1.0 g/cm³ or higher; preparing graphite B of which shapes of primary particles are flat, an average particle diameter of the primary particles ranges between 1 μm and 10 μm inclusive, and sizes of crystallites in a direction of a c-axis are 100 nm or larger; preparing paint by mixing the graphite A and the graphite B in the presence of a binder and a solvent; and applying the paint on a collector, drying the paint and then calendering.

Moreover, one or more embodiments of the present invention provide a lithium secondary battery including a positive electrode, the negative electrode for lithium secondary batteries and a non-aqueous electrolyte solution.

### BRIEF DESCRIPTION OF DRAWINGS

FIG. 1 is an enlarged view showing an outer appearance of graphite A used in Example 1, according to a scanning electron microscope (SEM).

FIG. 2 is an enlarged view showing an outer appearance of graphite B used in Example 1, according to a SEM.

FIG. 3 is a partial vertical cross-sectional view showing a lithium secondary battery of Example 1 schematically.

FIG. 4 is a top plan view showing the lithium secondary battery of Example 1 schematically.

FIG. 5 is a characteristic diagram showing cycle characteristics of respective lithium secondary batteries of Examples 1, 2 and 6 and Comparative examples 1 and 2 at 20° C.

FIG. 6 is a characteristic diagram showing capacity retention rates of the respective lithium secondary batteries of Examples 1 and 2 and Comparative examples 1 and 2 as cycle characteristics at 0° C., with respect to the cycle characteristics at 20° C.

### DESCRIPTION OF THE INVENTION

Embodiments of the present invention will be described below with reference to the accompanying figures.

In one or more embodiments, graphite A is used, of which primary particles have an average particle diameter ranging between 10 μm and 30 μm inclusive, and are spherically-shaped or elliptically-shaped. This is because, compared with squamation-shaped particles of general graphite, spherically-shaped or elliptically-shaped particles are hard to orient while being subjected to a press (calendering), are more advantageous for providing high-rate discharge characteristics and low-temperature characteristics, have smaller specific surface area, and accordingly have lower reactivity with an organic electrolyte solution. Thus, improved cycle characteristics are provided.

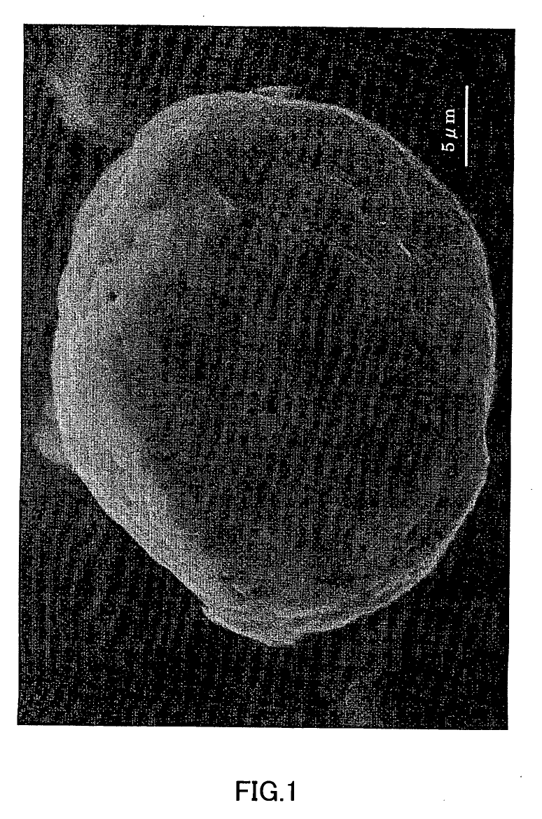

Here, the primary particles of the graphite A do not necessarily have perfect spherical or elliptical shapes, but may have substantially spherical or elliptical shapes, and may also have asperities on surfaces thereof like the primary particles (see FIG. 1) that is used in the below-mentioned Example 1. Moreover, the graphite A may include both of the spherically-shaped primary particles and the elliptically-shaped primary particles.

The reason for setting the average particle diameter of the primary particles to be in the range between 10 μm and 30 μm inclusive is because, when the average particle diameter is smaller than 10 μm, the cycle characteristics deteriorate due to the increased reactivity with the organic electrolyte solution, and when the average particle diameter is larger than 30 μm, dispersion stability of negative electrode paint deteriorate, which leads to deterioration of productivity, and asperities occurred on a surface of the negative electrode damage a separator, which may cause internal shorts.

In addition, sizes of crystallites of the graphite A in a direction of a c-axis need to be smaller than 100 nm, and preferably range from 60 nm to 90 nm. When the crystallites have such a size, a reaction with the organic electrolyte solution can be suppressed, whereby the cycle characteristics are improved.

Here, the sizes of the crystallites of the graphite A in the direction of the c-axis are obtained by Japan Society for the Promotion of Science method, based on a (002) diffraction line measured by a X-ray diffractometer, “RAD-RC” manufactured by RIGAKU Corporation.

Moreover, tap density of the graphite A need to be 1.0 g/cm³ or higher, preferably ranges from 1.1 g/cm³ to 1.3 g/cm³. When the graphite A has such tap density, a decrease of coating layer density can be suppressed, which results in high energy density.

Here, the tap density of the graphite A is obtained according to Japanese Industrial Standards (JIS K1469), by: measuring a weight of a sample of 100 cm³ disposed in a graduated cylinder with a capacity of 150 cm³; measuring a volume of the sample after tapping the graduated cylinder thirty times from a height of 5 cm; and calculating from these measurement values by a formula: A=W/V (A: the tap density, W: the weight of the sample (g), V: the volume of the sample after the tapping (cm³)).

Among such graphite A, a compound graphite, wherein at least a part of the surfaces is further covered with non-graphite carbon, is preferable. The reason for this is because non-graphite carbon has higher strength than graphite, and thus hardly generate deformation by the press, thereby maintaining the above-described advantages even after the electrode processing. Also, the non-graphite carbon prevents direct contact of the graphite with the organic electrolyte solution, and thus the reaction of the surfaces of the graphite with the organic electrolyte solution can be suppressed, thereby obtaining an effect of further improving the cycle characteristics.

Assuming that I₁₃₅₀ denotes Raman intensity at approximately 1350 cm⁻¹, I₁₅₈₀ denotes Raman intensity at approximately 1580 cm⁻¹ and a R-value of Raman spectrum is obtained by a formula: R=(I₁₃₅₀/I₁₅₈₀), a R-value of Raman spectrum of the graphite A is preferably 0.4 or larger when the graphite A is excited by an Ar laser with a wavelength of 5145 Å, and particularly preferably, ranges from 0.5 to 3.0. When the R-value is smaller than 0.4, since covering of the non-graphite carbon is not sufficient, deformation easily occurs due to the press, and the reaction of the surfaces of the graphite with the organic electrolyte solution is not suppressed, thus a preferable result for improving the cycle characteristics hardly can be obtained.

Here, the R-value is obtained by measuring the peak intensity I₁₅₈₀ at approximately 1580 cm⁻¹ and the peak intensity I₁₁₃₀ at approximately 1350 cm⁻¹ according to the Raman spectrum using the Ar laser with the wavelength of 5145 Å, and calculating an intensity ratio by the formula: (I₁₃₅₀/I₁₅₈₀).

Moreover, an axial ratio of the primary particles of the graphite A (a value obtained by dividing a maximum diameter of the primary particles by a minimum diameter of the primary particles) preferably is 1.2 or higher, and 3 or lower. When the axial ratio is 1.2 or higher, contact between graphite particles is improved, and an increase of contact resistance according to charge-discharge cycles is suppressed, thus being preferable. More preferably, the axial ratio is 1.5 or higher. In addition, when the axial ratio is higher than 3, the graphite particles are easily crushed while preparing negative electrode paint, and the thus newly generated surfaces of the graphite particles react with the organic electrolyte solution, which may lead to the deterioration of the cycle characteristics. In order to prevent this, the axial ratio is preferably 3 or lower, and more preferably, 2.5 or lower.

In one or more embodiments, a weight proportion of the graphite A preferably ranges between 10 wt % and 90 wt % inclusive, with respect to a sum weight of the graphite A and the graphite B, and particularly preferably ranges between 20 wt % and 80 wt % inclusive. When the weight proportion of the graphite A is lower than 10 wt %, an effect of improving the cycle characteristics due to the mix deteriorates. Also, when the weight proportion of the graphite A is higher than 90 wt %, a margin of manufacture for determining a condition of preparing the paint and a condition of the pressure forming treatment may decrease, and thus manufacturing cost may increase.

In one or more embodiments, the primary particles of graphite B need to be flat-shaped graphite particles with an average particle diameter ranging between 1 μm and 10 μm inclusive, and preferably, the primary particles aggregate or bond so as to disperse orientation faces thereof, thus forming secondary particles with an average particle diameter ranging between 10 μm and 30 μm inclusive. When preparing paint by: mixing the graphite B having such a structure of the secondary particles with the graphite A; applying the paint on a collector; drying the paint; and then calendering, since the graphite B contacts with and between the primary particles of the graphite A while the graphite B changes the shapes freely, a pass with high conductivity can be formed, and contact area of the graphite B with the graphite A having the large particle diameters increases, thus decreasing the contact resistance of the graphite B with the graphite A. Therefore, initial large-current properties are improved, which contributes to increase an utilization rate of active materials and improve the cycle characteristics.

When the average particle diameter of the primary particles of the graphite B decreases, since a capacity of the graphite B degreases, and electrode capacitance as a battery also decreases, the average particle diameter of the primary particles of the graphite B is set to be 1 μm or larger, preferably, 2 μm or larger, and more preferably, 4 μm or larger. In addition, when the average particle diameter of the primary particles of the graphite B increases, it becomes hard to increase the density and the capacity of the negative electrode, and an effect of decreasing the contact resistance of the graphite B with the graphite A deteriorates due to a decrease of contact points of the graphite B with the graphite A, thereby degrading an effect of improving the cycle characteristics. Therefore, the average particle diameter of the primary particles of the graphite B is set to be 10 μm or smaller, preferably, 8 μm or smaller, and more preferably, 7 μm or smaller.

Moreover, sizes of crystallites of the graphite B need to be 100 nm or larger, and preferably range from 105 nm to 150 nm. When the crystallites of the graphite B have such a size, the graphite B performs as a negative active material having a large capacity, and thus an electrode with a large capacitance can be obtained.

Here, the sizes of the crystallites of the graphite B in the direction of the c-axis are obtained by Japan Society for the Promotion of Science method, based on a (002) diffraction line measured by a X-ray diffractometer, “RAD-RC” manufactured by RIGAKU Corporation.

Moreover, an axial ratio of the primary particle of the graphite B (a value obtained by dividing a maximum diameter of a plate face by a plate thickness) preferably is 1.5 or higher, and 5 or lower. When the axial ratio is 1.5 or higher, similarly to the case of the graphite A, the contact between graphite particles is improved, and an increase of contact resistance according to the cycles is suppressed, thus being preferable. In addition, when the axial ratio is 5 or lower, deterioration of the cycle characteristics due to the crush of the graphite particles during the preparation of the negative electrode paint can be prevented, thus being preferable.

In one or more embodiments, at least one of the graphite A and the graphite B is preferably natural graphite, and more preferably, both of them are natural graphite. Natural graphite is low-cost and has a large capacity, thereby being utilized as an electrode with a high cost-performance.

In one or more embodiments, a lithium secondary battery is manufactured by: mixing the spherically-shaped or elliptically-shaped graphite A having the above-mentioned certain particle diameter and properties with the flat-shaped graphite B having the certain particle diameter and the properties as appropriate; preparing paint by mixing the graphite A and the graphite B in the presence of a binder and an appropriate solvent such as water; applying the paint on an appropriate collector such as copper foil; drying the paint; and performing a press using a roller or the like (a pressure forming treatment).

In one or more embodiments, the binder used for manufacturing the negative electrode preferably comprises a mixture of an aqueous resin (a resin having a property of being dissolved or dispersed into water) and a rubber-based resin. This is because the aqueous resin contributes to the dispersion of the graphite, and the rubber-based resin prevents exfoliation of a coating layer from the collector, which is caused by an expansion and a shrinkage of the electrode during the charge-discharge cycles.

Examples of the aqueous resin include polyvinyl pyrrolidone, polyepichlorohydrin, polyvinylpyridine, polyvinyl alcohol, and a cellulose resin such as carboxymethyl cellulose and hydroxypropyl cellulose, and a polyether resin such as polyethylene oxide and polyethylene glycol. Examples of the rubber-based resin include latex, a butyl rubber, a fluoro rubber, a styrene-butadiene rubber, polybutadiene, an ethylene-propylene-diene copolymer (EPDM). Among them, the most common example is a combination of carboxymethyl cellulose and a styrene-butadiene rubber.

In the thus manufactured negative electrode for lithium secondary batteries, since the graphite A having a high strength hardly generates deformation caused by the press, and the graphite B contacts with and between the primary particles of the graphite A while the graphite B changes the shapes freely during the press, a mixing effect of the graphite A and the graphite B can be exerted more as coating layer density of the negative electrode is higher. The coating layer density of the negative electrode after the press is preferably 1.4 g/cm³ or higher, and more preferably, 1.5 g/cm³ or higher. However, when the coating layer density is excessively high, even the combination of the graphite A and the graphite B provides a low utilization rate, thus the coating layer density is preferably 1.9 g/cm³ or lower, and more preferably, 1.8 g/cm³ or lower.

In one or more embodiments, various shapes of lithium secondary batteries such as cylindrical shapes, rectangular shapes, flat shapes and coin shapes, by: using the above-mentioned negative electrode for lithium secondary batteries; disposing this negative electrode and a positive electrode that includes a complex oxide containing lithium such as LiCoO₂, LiNiO₂ and LiMn₂O₄ as a positive active material, in a battery case via a separator such as a microporous polyethylene film; injecting liquid nonaqueous electrolyte that is obtained by dissolving a solute such as LiPF₆ into a nonpolar solvent such as ethylene carbonate and methyl ethyl carbonate, into the battery case; and sealing the battery case.

In the above-mentioned lithium secondary battery using the negative electrode for lithium secondary batteries of the present embodiment, it is preferable to add vinylene carbonate into the nonaqueous electrolyte, because more stable cycle characteristics can be obtained. An amount of the vinylene carbonate added is preferably 0.5 wt % or higher with respect to a weight of the nonaqueous electrolyte, more preferably, 1 wt % or higher, and further more preferably, 2 wt % or higher. When the amount of the vinylene carbonate is excessively high, storage characteristics tend to deteriorate, and thus the amount is preferably 6 wt % or lower, more preferably, 5 wt % or lower, and further preferably, 4 wt % or lower.

As mentioned above, one or more embodiments can provide a negative electrode for lithium secondary batteries with a large capacity and excellent cycle characteristics and a lithium secondary battery using the negative electrode, by using a combination of spherically-shaped or elliptically-shaped graphite A having a certain particle diameter and properties and flat-shaped graphite B having a certain particle diameter and properties.

Description of Examples 1 to 6 will be provided below as examples of embodiments of the present invention, accompanied with Comparative examples 1 to 3 for being compared these Examples, in order to explain the present invention more specifically. However, the present invention is not limited to these examples.

### EXAMPLE 1

As graphite A, graphite A1 having the following features was used: crystallites in a direction of a c-axis had a size of 88.5 nm; interplanar spacing d₀₀₂ on a (002) face was 0.3357 nm; an average particle diameter of primary particles observed by a SEM was 17 μm; a R-value of Raman spectrum was 1.670; tap density was 1.19 g/cm³; a specific surface area was 3.12 m²/g; and surfaces had pitches formed thereon by being sintered and were covered with 3 wt % to 4 wt % of non-graphite carbon. FIG. 1 shows an appearance of this graphite A1 according to the SEM. As shown in FIG. 1, the graphite A1 included at least substantially elliptically-shaped primary particles.

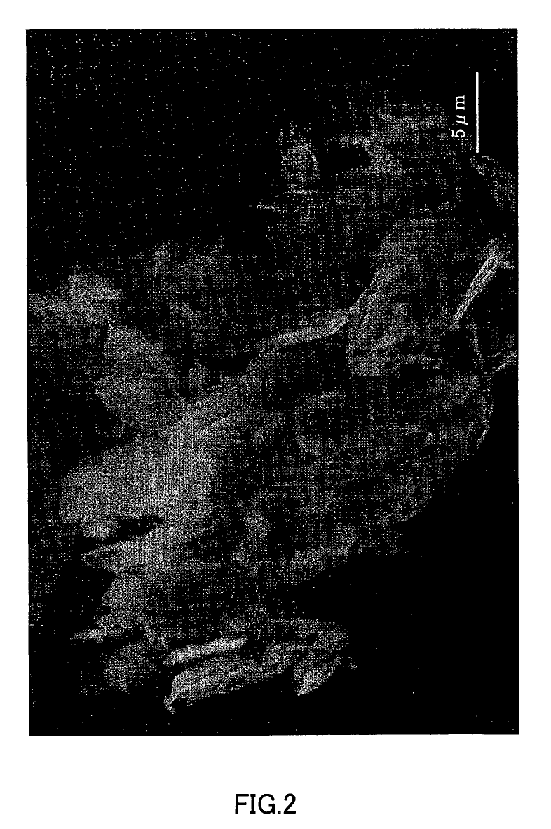

As graphite B, graphite having the following features was used: crystallites in a direction of a c-axis had a size of 116 nm; interplanar spacing on a (002) face (d₀₀₂) was 0.3362 nm; an average particle diameter of secondary particles observed by the SEM was 19 μm; an average plate diameter of a flat-shaped primary particles ranges from 1 μm to 9 μm; tap density was 0.59 g/cm³; and a specific surface area was 4.40 m²/g. FIG. 2 shows an appearance of this graphite B according to the SEM. As shown in FIG. 2, the graphite B included the secondary particles formed by the aggregation of the flat-shaped primary particles.

A negative active material was obtained by mixing the graphite A1 and the graphite B in a ratio of 30 wt %:70 wt %. This negative active material including these two kinds of graphite, and carboxymethyl cellulose (CMC) and a styrene-butadiene rubber (SBR) which were as a binder were mixed in a ratio of 98 wt %: 1 wt %: 1 wt % with water so as to prepare negative electrode paint. After applying this negative electrode paint on both surfaces of copper foil (thickness: 10 μm) as a negative electrode collector, the water as a solvent was dried, and a press was performed using a roller. Here, coating layer density was 1.50 g/cm³. Subsequently, the thus painted copper foil was cut, and a lead was welded, thereby manufacturing a narrow piece of a negative electrode.

In addition, positive electrode paint was prepared by mixing LiCoO₂ as a positive active material, carbon black as a conductive agent and polyvinylidene fluoride as a binder in a ratio of 90 wt %:5 wt %:5 wt % with N-methyl-2-pyrrolidone (NMP) as a solvent.

After applying this positive electrode paint on both surfaces of an aluminum foil (thickness: 15 μm) as a positive electrode collector, the NMP as the solvent was dried, and a press was performed using the roller. Subsequently, the thus painted aluminum foil was cut, and a lead was welded, thereby manufacturing a narrow piece of the positive electrode.

Next, the above-stated narrow piece of the positive electrode and the above-stated narrow piece of the negative electrode were rolled into a spiral, sandwiching a microporous polyethylene film with a thickness of 20 μm as a separator so as to form rolled electrodes, and these rolled electrodes filled a bottomed cylindrical aluminum sheathed can with a width of 34.0 mm, a thickness of 4.0 mm and a height of 50.0 mm as a battery case. The above-stated positive electrode was welded to a positive terminal via a positive electrode current collecting tab, and the above-stated negative electrode was welded to a negative terminal via a negative electrode current collecting tab.

Also, liquid nonaquous electrolyte was prepared by dissolving LiPF₆ by a ratio of 1.2 mol/dm³ into a mixed solution that was obtained by mixing ethylene carbonate (EC) and methyl ethyl carbonate (MEC) in a volume ratio of 1:2, and then vinylene carbonate (VC) was further added into the nonaqueous electrolyte by 3.0 wt % with respect to a weight of the nonaqueous electrolyte. Next, this liquid nonaqueous electrolyte was injected into the above-stated sheathed can and was infiltrated therein sufficiently, and then the sheathed can was sealed, thereby manufacturing a rectangular-shaped lithium secondary battery.

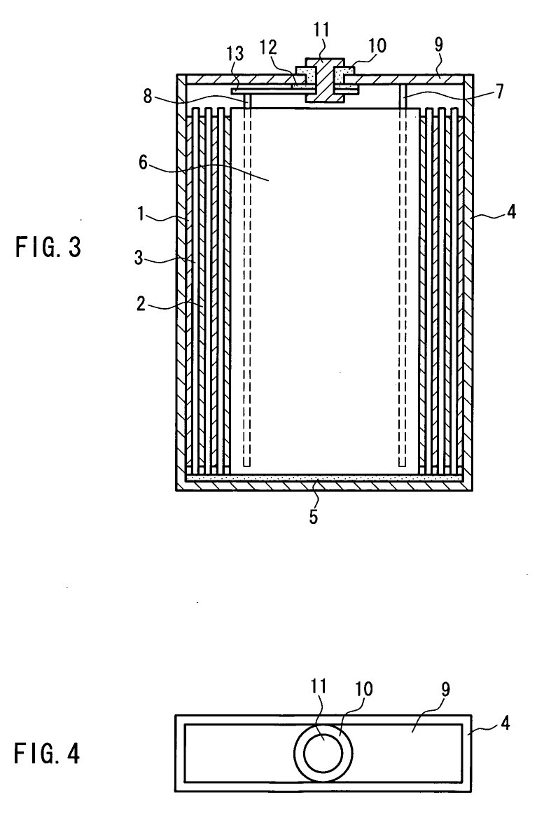

FIGS. 3 and 4 show this rectangular-shaped lithium secondary battery, more specifically, FIG. 3 is a partial vertical cross-sectional view of the battery, and FIG. 4 is a top plan view of the battery.

In these figures, reference numeral 1 denotes a positive electrode, reference numeral 2 denotes a negative electrode, reference numeral 3 denotes a separator, reference numeral 4 denotes a battery case, reference numeral 5 denotes an insulator, reference numeral 6 denotes a rolled electrode, reference numeral 7 denotes a positive lead, reference numeral 8 denotes a negative lead, reference numeral 9 denotes a cover plate, reference numeral 10 denotes an insulating packing, reference numeral 11 denotes a terminal, reference numeral 12 denotes an insulator, and reference numeral 13 denotes a lead plate.

### EXAMPLE 2

A rectangular-shaped lithium secondary battery was manufactured similarly to Example 1, except using a negative active material that was obtained by mixing the graphite A1 and the graphite B in a ratio of 70 wt %:30 wt %. Density of a negative electrode coating layer was 1.50 g/cm³.

### EXAMPLE 3

A rectangular-shaped lithium secondary battery was manufactured similarly to Example 1, except using a negative active material that was obtained by mixing the graphite A1 and the graphite B in a ratio of 50 wt %:50 wt %. Density of a negative electrode coating layer was 1.51 g/cm³.

### EXAMPLE 4

A rectangular-shaped lithium secondary battery was manufactured similarly to Example 1, except using a negative active material that was obtained by mixing the graphite A1 and the graphite B in a ratio of 90 wt %:10 wt %. Density of a negative electrode coating layer was 1.52 g/cm³.

### EXAMPLE 5

A rectangular-shaped lithium secondary battery was manufactured similarly to Example 1, except using a negative active material that was obtained by mixing the graphite A1 and the graphite B in a ratio of 10 wt %:90 wt %. Density of a negative electrode coating layer was 1.48 g/cm³.

### COMPARATIVE EXAMPLE 1

A rectangular-shaped lithium secondary battery was manufactured similarly to Example 1, except using only the graphite B as a negative active material. Density of a negative electrode coating layer was 1.50 g/cm³.

### COMPARATIVE EXAMPLE 2

A rectangular-shaped lithium secondary battery was manufactured similarly to Example 1, except using only the graphite A1 as a negative active material. Density of a negative electrode coating layer was 1.50 g/cm³.

### EXAMPLE 6

As graphite A, graphite A2 having the following features was used: crystallites in a direction of a c-axis had a size of 88.5 nm; interplanar spacing on a (002) face (d₀₀₂) was 0.3357 nm; an average particle diameter of primary particles observed by the SEM was 17 μm; a R-value of Raman spectrum was 0.112; tap density was 1.20 g/cm³; a specific surface area was 3.45 m²/g; and surfaces had no pitch formed thereon and no non-graphite carbon covering thereon. A rectangular-shaped lithium secondary battery was manufactured similarly to Example 1, except using a negative active material that was obtained by mixing the graphite A2 and the graphite B in a ratio of 30 wt %:70 wt %. Density of a negative electrode coating layer was 1.50 g/cm³.

### COMPARATIVE EXAMPLE 3

A rectangular-shaped lithium secondary battery was manufactured similarly to Example 6, except using only the graphite A2 as a negative active material. Density of a negative electrode coating layer was 1.51 g/cm³.

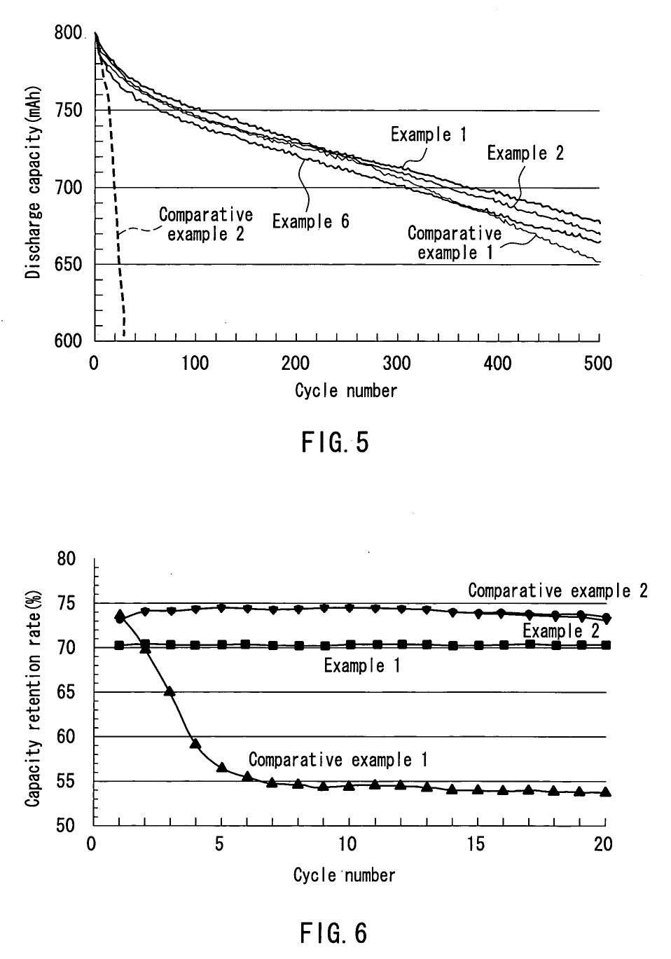

In order to examine performances of the respective lithium secondary batteries of the above-mentioned Examples 1 to 6 and Comparative examples 1 to 3, cycle testing was performed at 20° C. by: charging at constant current of 800 mA and constant voltage of 4.2 V for 2.5 hours; discharging at constant current of 800 mA; and then terminating the discharge at voltage of 3.0 V. In addition, a capacity retention rate was obtained by dividing a value of a discharge capacity after 400 cycles by a value of a discharge capacity in a first cycle. Table 1 shows the results. Moreover, FIG. 5 shows the results of the cycle testing of the batteries of Examples 1, 2 and 6 and Comparative examples 1 and 2.

Furthermore, cycle testing was performed particularly to the lithium secondary batteries of Examples 1 and 2 and Comparative examples 1 and 2 at 0° C. as well as at 20° C., similarly to the above-mentioned cycle testing. Then, a capacity retention rate of the each battery was obtained by dividing a value of a discharge capacity at 0° C. by the value of the discharge capacity at 20° C. FIG. 6 shows the results.

TABLE 1

| | discharge | discharge | capacity |
|---|---|---|---|
| | capacity | capacity | retention |
| | in a first | after 400 | rate |
| | cycle (mAh) | cycles (mAh) | (%) |
| Example 1 | 791 | 696 | 87.99 |
| Example 2 | 796 | 689 | 86.56 |
| Example 3 | 789 | 691 | 87.58 |
| Example 4 | 795 | 685 | 86.16 |
| Example 5 | 791 | 687 | 86.85 |
| Comparative example 1 | 797 | 681 | 85.45 |
| Comparative example 2 | 790 | — | — |
| Example 6 | 782 | 671 | 85.80 |
| Comparative example 3 | 775 | — | — |

From the above results in Table 1 and FIG. 5, it is found that the lithium secondary batteries of Examples 1 to 5 using the negative electrodes which included the mixture of the graphite A1 and the graphite B maintained the discharge capacity to be 85% or larger even after 400 cycles, with respect to the discharge capacity in the first cycle, and accordingly, the cycle characteristics was considerably superior. Whereas, in Comparative example 2, the discharge capacity of the lithium secondary battery using only the graphite A1 decreased to be smaller than 50% after 30 cycles, with respect to the discharge capacity thereof in the first cycle, and accordingly, the cycle testing was discontinued. Also, it is found that the lithium secondary batteries using the mixture of the graphite A1 and the graphite B provided the cycle characteristics which is equivalent or superior to the lithium secondary battery of Comparative example 1 using only the graphite B.

Moreover, it is found that, similarly to the above mentioned case, the lithium secondary battery of Example 6 using the negative electrode including the mixture of the graphite A2 without the covering of non-graphite carbon and the graphite B provided considerably superior cycle characteristics, compared with the lithium secondary battery of Comparative example 3 using only the graphite A2, and thus a remarkable effect was able to be obtained. From the comparison of this Example 6 with Example 1, it also was found that the discharge capacity in the first cycle was increased by the covering of the non-graphite carbon.

Next, from the above result of FIG. 6, it is found that the lithium secondary batteries of Examples 1 and 2 using the negative electrodes which included the mixture of the graphite A1 and the graphite B provided considerably superior cycle characteristics at 0° C., compared with the lithium secondary battery of Comparative example 1 using only the graphite B, and the cycle characteristics of the lithium secondary batteries of Examples 1 and 2 are almost equivalent to that of the lithium secondary battery of Comparative example 2 using only the graphite A1.

From the above mentioned results of FIGS. 5 and 6 and Table 1, it is found to be clear that, according to embodiments of the present invention, the negative electrode for lithium secondary batteries with excellent cycle characteristics and low-temperature characteristics can be obtained by forming the negative electrode including the mixture of the graphite A and the graphite B.

It is supposed that the reason why embodiments of the present invention were able to provide the above described excellent effect is because conductivity between the graphite A and the graphite A, conductivity between the graphite A and the graphite B and conductivity between the active material and the copper foil increased due to the deformation of the used graphite B during the press, and the reaction of the surfaces of the graphite with the nonaqueous electrolyte was suppressed by the covering of the non-graphite carbon.

### INDUSTRIAL APPLICABILITY

As mentioned above, the lithium secondary battery of one or more embodiments of the present invention, which has a large capacity and excellent cycle characteristics and is low-cost, can be used as a large-capacity secondary battery that can be charged and discharged repeatedly, for portable electronic equipment such as mobile phones and notebook-sized personal computers and the like.

1. A negative electrode for lithium secondary batteries, comprising a negative active material and a binder,
wherein the negative active material comprises graphite A and graphite B,
shapes of primary particles of the graphite A are spherical or elliptical,
an average particle diameter of the primary particles of the graphite A ranges between 10 μm and 30 m inclusive,
sizes of crystallites of the graphite A in a direction of a c-axis are smaller than 100 nm and tap density of the graphite A is 1.0 g/cm³ or higher,
shapes of primary particles of the graphite B are flat,
an average particle diameter of the primary particles of the graphite B ranges between 1 μm and 10 μm inclusive, and
sizes of crystallites of the graphite B in a direction of a c-axis are 100 nm or larger.

2. The negative electrode for lithium secondary batteries according to claim 1, wherein at least a part of surfaces of the graphite A is further covered with non-graphite carbon.

3. The negative electrode for lithium secondary batteries according to claim 1,
wherein, I₁₃₅₀ denotes Raman intensity at approximately 1350 cm⁻¹, I₁₅₈₀ denotes Raman intensity at approximately 1580 cm⁻¹ and a R-value of Raman spectrum is obtained by a formula: R=(I₁₃₅₀/I₁₅₈₀),
a R-value of Raman spectrum of the graphite A is 0.4 or larger when the graphite A is excited by an Ar laser with a wavelength of 5145 Å.

4. The negative electrode for lithium secondary batteries according to claim 1, wherein the primary particles of the graphite B aggregate or bond so as to form secondary particles, and an average particle diameter of the secondary particles ranges between 10 μm and 30 μm inclusive.

5. The negative electrode for lithium secondary batteries according to claim 1, wherein a weight proportion of the graphite A ranges between 10 wt % and 90 wt % inclusive, with respect to a sum weight of the graphite A and the graphite B.

6. The negative electrode for lithium secondary batteries according to claim 1, wherein the binder comprises a mixture of an aqueous resin and a rubber-based resin.

7. A method for manufacturing a negative electrode for lithium secondary batteries comprising the steps of:
preparing graphite A of which shapes of primary particles are spherical or elliptical, an average particle diameter of the primary particles ranges between 10 μm and 30 μm inclusive, sizes of crystallites in a direction of a c-axis are smaller than 100 nm, and tap density is 1.0 g/cm³ or higher;
preparing graphite B of which shapes of primary particles are flat, an average particle diameter of the primary particles ranges between 1 μm and 10 μm inclusive, and sizes of crystallites in a direction of a c-axis are 100 nm or larger;
preparing paint by mixing the graphite A and the graphite B in the presence of a binder and a solvent; and
applying the paint on a collector, drying the paint and then performing a pressure forming treatment.

8. The method for manufacturing the negative electrode for lithium secondary batteries according to claim 7, wherein at least a part of surfaces of the graphite A is further covered with non-graphite carbon.

9. The method for manufacturing the negative electrode for lithium secondary batteries according to claim 7,
wherein, I₁₃₅₀ denotes Raman intensity at approximately 1350 cm⁻, I₁₅₈₀ denotes Raman intensity at approximately 1580 cm⁻¹ and a R-value of Raman spectrum is obtained by a formula: R=(I₁₃₅₀/I₁₅₈₀),
a R-value of Raman spectrum of the graphite A is 0.4 or larger when the graphite A is excited by an Ar laser with a wavelength of 5145 Å.

10. The method for manufacturing the negative electrode for lithium secondary batteries according to claim 7, wherein the primary particles of the graphite B aggregate or bond so as to form secondary particles, and an average particle diameter of the secondary particles ranges between 10 μm and 30 μm inclusive.

11. The method for manufacturing the negative electrode for lithium secondary batteries according to claim 7, wherein a weight proportion of the graphite A ranges between 10 wt % and 90 wt % inclusive, with respect to a sum weight of the graphite A and the graphite B.

12. The method for manufacturing the negative electrode for lithium secondary batteries according to claim 7, wherein the binder comprises a mixture of an aqueous resin and a rubber-based resin.

13. A lithium secondary battery, comprising a positive electrode, a negative electrode and nonaqueous electrolyte,
wherein the negative electrode comprises a negative active material and a binder,
the negative active material comprises graphite A and graphite B, shapes of primary particles of the graphite A are spherical or elliptical,
an average particle diameter of the primary particles of the graphite A ranges between 10 μm and 30 μm inclusive,
sizes of crystallites of the graphite A in a direction of a c-axis are smaller than 100 nm and tap density of the graphite A is 1.0 g/cm³ or higher,
shapes of primary particles of the graphite B are flat,
an average particle diameter of the primary particles of the graphite B ranges between 1 μm and 10 μm inclusive, and
sizes of crystallites of the graphite B in a direction of a c-axis are 100 nm or larger.

14. The lithium secondary battery according to claim 13, wherein at least a part of surfaces of the graphite A is further covered with non-graphite carbon.

15. The lithium secondary battery according to claim 13,
wherein, I₁₃₅₀ denotes Raman intensity at approximately 1350 cm⁻¹, I₁₅₈₀ denotes Raman intensity at approximately 1580 cm⁻¹ and a R-value of Raman spectrum is obtained by a formula: R=(I₁₃₅₀/I₁₅₈₀),
a R-value of Raman spectrum of the graphite A is 0.4 or larger when the graphite A is excited by an Ar laser with a wavelength of 5145 Å.

16. The lithium secondary battery according to claim 13, wherein the primary particles of the graphite B aggregate or bond so as to form secondary particles, and an average particle diameter of the secondary particles ranges between 10 μm and 30 μm inclusive.

17. The lithium secondary battery according to claim 13, wherein a weight proportion of the graphite A ranges between 10 wt % and 90 wt % inclusive, with respect to a sum weight of the graphite A and the graphite B.

18. The lithium secondary battery according to claim 13, wherein the binder comprises a mixture of an aqueous resin and a rubber-based resin.
